(19) United States
(12) Patent Application Publication
(10) Pub. No.: US 2014/0325688 A1
(43) Pub. Date: Oct. 30, 2014

(54) TAMPERPROOF HOUSING MODULE

(71) Applicants: James A Cashin, San Luis Obispo, CA (US); Brian Dunn, Arroyo Grande, CA (US)

(72) Inventors: James A Cashin, San Luis Obispo, CA (US); Brian Dunn, Arroyo Grande, CA (US)

(73) Assignee: ULTRA STEREO LABS, INC., SAN LUIS OBISPO, CA (US)

(21) Appl. No.: 13/871,912

(22) Filed: Apr. 26, 2013

(51) Int. Cl. G06F 21/87

(52) U.S. Cl. CPC G06F 21/87
USPC 726/34

(57) ABSTRACT

A tamperproof housing assembly for a PCB is disclosed where unauthorized access to the circuitry or contents of the housing assembly is prohibited. In a preferred embodiment, the housing assembly comprises a top cover, a bottom cover and a PCB sandwiched between the top and bottom covers using at least one interlocking system and a tamper sensor that is armed when the assembly is fully and properly assembled. In a preferred embodiment, there are at least 2 two-part interlocking systems are configured such that the movement of each part of the interlocking system relative to the other is limited to one axis. Even when the cover of the housing assembly is moved in a contrary or oblique direction after assembly, the physical and electronic security and integrity are maintained, as any movement will set off the tamper notification.

### BACKGROUND OF THE INVENTION

1. Field of the Invention

The invention relates to tamperproof housings that are used to encase circuitry, modules or devices that contain proprietary or cryptographic information, hazardous materials, or the like which need to be protected from tampering by unauthorized personnel.

2. Background of the Invention

In the motion picture and other industries, there is a need for a housing or module that is tamperproof such that circuitry and/or information contained therein cannot be accessed by unauthorized persons. (As used herein “housing” and “module” are meant to be interchangeable.) In the motion picture industry it is especially important to have such a module so that unauthorized persons cannot access or decode digital movies contained within such modules to prevent piracy of the contents thereof. In addition, the United States has enacted the United States Federal Information Processing Standard (“FIPS”) 140-2. FIPS 140-2 to specifically address security requirements for digital media to prevent tampering of modules containing the digital media and the inherent piracy that occurs as a result. FIPS 140-2 specifies security requirements that must be satisfied by any cryptographic module, by providing four increasing, qualitative levels intended to cover a wide range of potential applications and environments. The areas covered, related to the secure design and implementation of a cryptographic module, include specification; ports and interfaces; roles, services, and authentication; finite state model; physical security; operational environment; cryptographic key management; electromagnetic interference/electromagnetic compatibility (EMI/EMC); self-tests; design assurance; and mitigation of other attacks.

In the motion picture art, digital media may be stored and encoded within a media block. Prior art media block assemblies may be comprised of two metal covers, one on each side of the printed circuit board (PCB). The prior art media block assemblies may be held together with screws inserted through the first cover, the PCB and the second cover. This type of assembly also protects and removes heat from the electronics under normal usage and prevents visual access to the components and circuitry as it is hidden between the covers.

Some prior art assemblies also contain a plurality of tamper switches surrounding the media block to prevent access to the interior thereof. However, one issue with the prior art assembly is that even with a plurality of the tamper switches, someone could still clamp the covers to the circuit board so that the cover screws could be removed and at least one of the covers could be pried upward to gain access to the circuitry and/or access keys that inter alia decode the audio and video media without setting off the tamper switches. As a result, some of these prior art assemblies failed FIPS testing, because a probe could be inserted under the cover with only the smallest of gaps without setting off the tamper switches.

Another prior art method used to prevent tampering of the media block was to envelope the assembly and/or all or some of the electronics in epoxy such that if someone attempted to open the housing, the circuitry contained therein would be totally or partially destroyed. However, when such a method is used, no one, including authorized personnel, can access the digital media without destroying it. Thus, access to the digital media by even authorized persons was hindered. Further, this method could damage the equipment rendering it useless.

Thus, it is desirable in the art to find a method and device that would hinder tampering and/or piracy of the electronics and/or digital media but not hinder access thereto by authorized personnel. It also is desirable in the art to provide an assembly that can be opened by authorized personnel without permanently damaging the electronics and still prevent tampering by unauthorized persons.

This method and device would be applicable to any unit in which tampering might be an issue, such as fire alarms and smoke detectors, carbon monoxide detectors, computer memories, or any circuit containing cryptographic information therein.

### SUMMARY OF THE INVENTION

The present invention comprises a tamperproof housing for a digital media block module or assembly, a fire alarm, or any other electronic circuitry or hazardous material for which unauthorized access is prohibited. Although the invention will be described with respect to digital media blocks that are used in the motion picture industry, the present invention can be used in other industries and in other applications with suitable modifications. Likewise although the invention has been described in a rectangular form, the shape of the present invention can be modified so that it can be round, oblong, square or any other geometric shape.

In a preferred embodiment of the present invention, the module comprises a top cover, a bottom cover and a printed circuit board (“PCB”) that is sandwiched between the top and bottom covers using at least one interlocking system and a tamper sensor that is armed when the assembly is properly fully assembled. In the preferred embodiment of the invention, the module hinders tampering and/or piracy of the electronics and/or digital media and, if desired, still provides access to the electronics therein by authorized personnel. In other words, depending on the parameters set by the electronics on the PCB which determines what action is taken upon receipt of a tamper notification from the tamper sensor, after it is fully assembled and armed, the module can be opened by authorized personnel without permanently damaging all of the electronics but still prevent tampering by unauthorized persons.

In a preferred embodiment of the present invention, there are at least 2 two-part interlocking systems located within opposite facing sides of the module. The two parts are configured such that the movement of each part of the interlocking system relative to the other is limited to one axis. In a preferred embodiment, the two-part interlocking system comprises a male part and a female part. The female parts are configured so that they will only allow their corresponding male parts to move along the same axis in one direction linearly or rotationally after the male parts are inserted.

In a preferred embodiment, the male parts are located on the PCB and the interlocking female parts are located on the cover facing the side of the PCB on which the male parts are located. In a preferred embodiment of the present invention, once the male parts have been inserted into the female parts within the cover, at least one male part on each side of the cover is held in place by a set screw or other type of mechanical retention or a locking mechanism.

In a preferred embodiment, the tamper sensor located within the module becomes armed when the module is fully assembled. (As used herein “sensor” and “switch” may be used interchangeably.) The tamper sensor may be a microswitch, an optical switch, an electrical or magnetic sensor, or any other type of triggerable sensor. Although a preferred embodiment of the invention uses a single tamper sensor, alternate embodiments may use more than one sensor. In a preferred embodiment, the sensor becomes armed mechanically, electrically, optically or any combination thereof, when the male part and female parts of the interlocking system are fully engaged and in their locked position. Once the tamper sensor is armed, any attempt to pull the two covers apart will result in tripping the sensor. In a preferred embodiment the tamper switch is placed in a central location either on the male side of the PCB or on the cover that is installed last. In a preferred embodiment of the present invention, the tamper switch is centrally located on the male side of the PCB. In an alternate embodiment, the tamper sensor is centrally located within the cover that is assembled last, with the trigger installed in a corresponding location on the PCB. In a preferred embodiment, the tamper switch is a microswitch with an actuator arm. As the module is fully assembled, the actuator arm will depress and eventually come to rest against a block located on the last cover to be installed. When the actuator is fully depressed, the tamper sensor is armed. In an alternate embodiment, the tamper switch is located on a cover with the corresponding block located on the facing side of the PCB so that the tamper switch will become armed by the block when the male and female parts are fully engaged and the module is fully assembled. In a preferred embodiment there is at least one armed tamper switch. However, in other embodiments a plurality of tamper switches may be used.

In addition, because the female part is configured to only allow movement of the corresponding male part in a single direction, in a preferred embodiment of the present invention, once the module is fully assembled, entry into the protected area is prevented by requiring motion contrary or oblique to the original access. Further, even when the cover is moved in the contrary or oblique direction, the physical and electronic security and integrity are maintained, as any movement in any direction will set off the tamper notification. Specifically, any attempt to remove any part of a cover will activate the tamper notification before the cover can travel far enough to be removed. Thus, whenever someone attempts to gain access to the assembly or tries to tamper with the media block, a tamper notification will be created rendering the access keys or circuitry contained within the module inoperable. In alternate embodiments of some modules, when the tamper sensor is tripped, the access keys and/or circuitry within the module will be destroyed.

It is also contemplated that the module of the present invention has uses outside of the motion picture art, such as in the fire alarm housing art, computer art, or the television or electronics art, or any other art in which tampering with internal electronics or hazardous materials contained within the module is prohibited.

### BRIEF DESCRIPTION OF THE DRAWINGS

FIG. 1 is an exploded view of a preferred embodiment of the system of the present invention.

FIG. 2 is a cross-sectional side view of FIG. 1 in which the module has been fully assembled.

FIG. 3 is an exploded view of an alternate preferred embodiment of the system of the present invention.

FIG. 4 is a cross-sectional side view of FIG. 3 before the module has been fully assembled.

FIG. 5 is a cross-sectional side view of FIG. 3 before the module has been fully assembled.

FIG. 6 is a plan view of the bottom of the PCB after it has been attached to the top cover in FIG. 3.

### DETAILED DESCRIPTION OF THE DRAWINGS

As used herein, the words “module” and “assembly” are used interchangeably when referring to the device of the present invention. In the following descriptions of the invention, terms such as “top”, “bottom,” “first cover” and “second cover”, and the like are used herein merely for ease of description and refer to the orientation of the components shown in the figures and are not meant to limit the invention in any way.

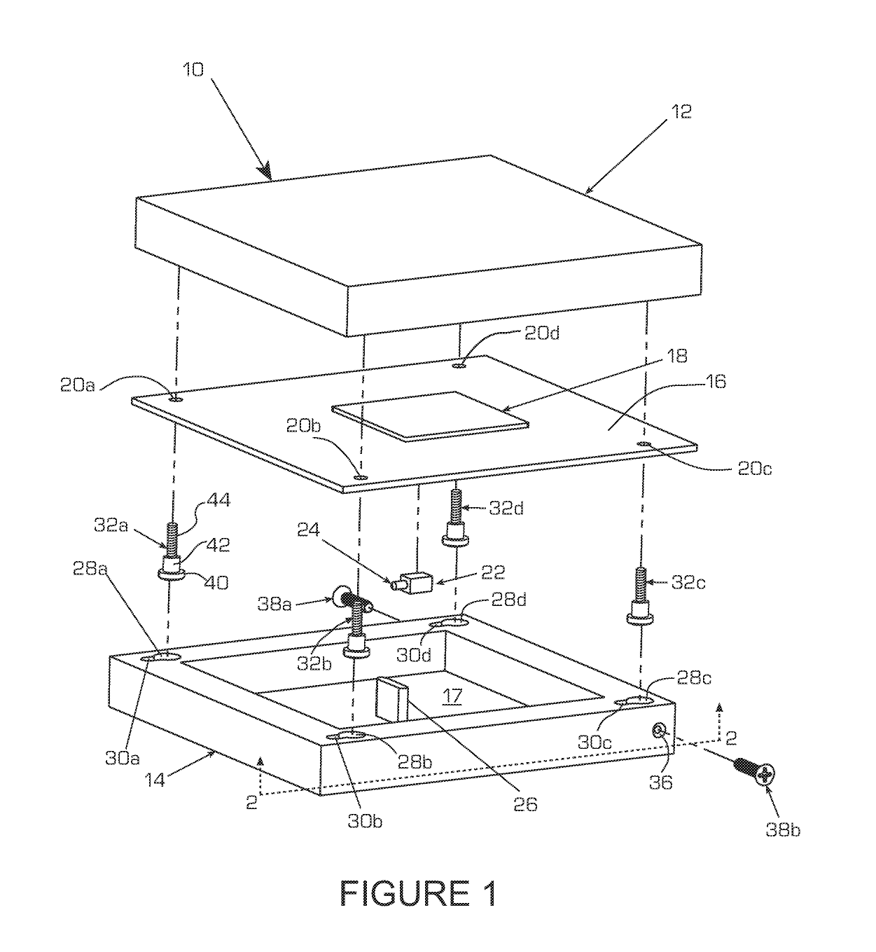

Referring first to FIG. 1, a preferred embodiment of the present invention is shown in exploded form. There is at least one area of sensitive circuitry 18 on the PCB 16 that needs to be protected from tampering. As shown in FIG. 1, in a preferred embodiment, the circuit 18 is placed in the middle of the PCB 16. However, the circuit 18 to be protected may be placed anywhere on the PCB 16 with suitable modification of the other components of the present invention.

In a preferred embodiment used in the movie industry, the circuit 18 comprises a cryptographic circuit that contains access keys (not shown) that decode video and audio media and then transfer the video and audio media to a digital projector and sound system. In addition, in a preferred embodiment of the present invention, the access keys may also watermark the audio and/or video media. However, any circuitry (including, but not limited to, fire and/or smoke alarm circuitry, carbon monoxide circuitry, radioactive detector circuitry, high voltage circuitry, cryptographic circuitry or any other circuitry, hazardous material or combination of same) that needs to be enclosed in a tamperproof module or assembly may be enclosed using the device of the present invention with suitable modification of the footprint of the device. Thus, while the module 10 of the present invention is shown in FIGS. 1-6 as comprising a rectangular box, the footprint of the module 10 may be square, oblong, circular or any other geometric shape with suitable modification of the other components.

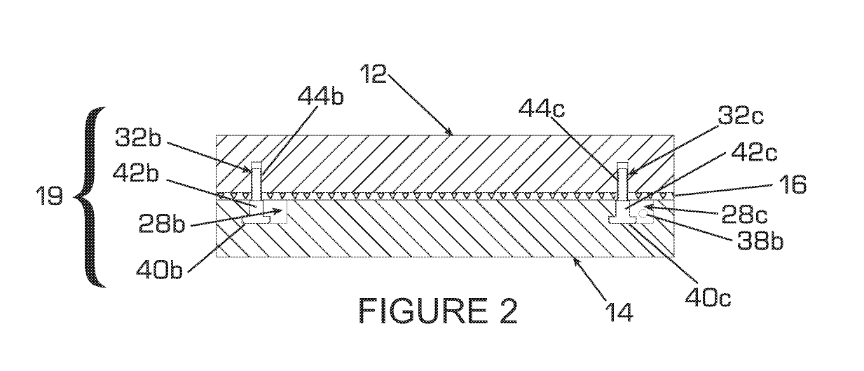

Referring next to FIGS. 1 and 2, the module 10 comprises a top cover 12, a bottom cover 14 and a printed circuit board (“PCB”) 16 that is sandwiched between the top and bottom covers 12 and 14 using at least one interlocking system 19 and a tamper sensor 22 that is armed when the assembly is fully and properly assembled. The interlocking system 19 locks the two covers 12 and 14 together during assembly sandwiching the PCB 16 in between. In a preferred embodiment, such as shown in FIGS. 1 and 2, there are 2 two-part interlocking systems, one for each side of the module.

Each interlocking system 19 comprises two parts that are configured such that the movement of each part relative to the other is limited to one axis. In a preferred embodiment, the two-part interlocking system 19 comprises a male part 32 and a female part 28. The female parts 28 are configured so that they will only allow their corresponding male parts 32 to move along the same axis linearly or rotationally in one direction after the male parts are inserted and to move in a contrary or oblique direction during disassembly.

In a preferred embodiment such as is shown in FIGS. 1 and 2, the male parts 32 are attached to the PCB 16. The respective interlocking female parts 28 for each of the male parts 32 are located on the cover 14 facing the side of the PCB on which the male parts are located. In a preferred embodiment of the present invention, once the male parts 32 have been inserted into the female parts 28 within the cover, at least one male part 32c and 32d on each side of the cover 14 is held in place by a set screw 38a and 38b or other type of mechanical retention or a locking mechanism.

Referring more specifically to FIG. 1, in a preferred embodiment of the present invention, the female parts 28 each comprise a keyhole shaped slot 28 which are proximate each corner of the bottom cover 14. The direction and orientation of each of the keyhole slots 28a, 28b, 28c and 28d are the same so that the large ends of the keyhole shaped slot 28 are on the same side relative to their narrower ends 30. In a preferred embodiment such as is shown in FIGS. 1 and 2, the male parts 32 are shoulder bolts 32, which are fabricated so that they have a head 40 and a shoulder 42. The size of the heads 40 and shoulders 42 are such that must completely fit within the larger opening of the keyhole shaped slots and be capable of moving along the grove in its narrower end without coming out. During assembly, when the shoulder bolts reach the end of the narrower end of the keyhole shaped slot opposite the larger end, the module will be completely assembled. In addition, in a preferred embodiment, each shoulder bolt 32 has a threaded shaft 44 extending from the shoulder portion 42 and is long enough to extend through the PCB 16 and terminate within the top cover 12. In this embodiment, the shoulder bolts, which hold the module together, may not be accessed from the outside of the module. In a preferred embodiment, the shaft 44 has a smaller diameter than the shoulder portion 42, so that when the PCB 16 is attached to the top cover 12, that assembly can rest fully on the shoulder bolts 32 before being attached to bottom cover. In a preferred embodiment, the bottom 14 and top covers 12 are configured so that the shoulder bolts 32 can replace the original cover screws that covered the sensitive cryptographic circuitry in prior art units.

During assembly of a preferred embodiment such as is shown in FIG. 1, the PCB 16 is first affixed to the top cover 12 using shoulder bolts 32. The PCB 16 has holes 20a, 20b, 20c and 20d proximate the corners thereof through which the shoulder bolts 32 are threaded. In an alternate embodiment, the PCB 16 may be affixed to the bottom cover 14 first using shoulder bolts threaded through the PCB 16 with suitable modification of the top cover and other components such that the keyhole shaped slots 28 would be the top cover 14 and the top cover 14 would be the last component to be installed during assembly.

In an alternate embodiment, a pattern other than a keyhole-shape is used with suitable modifications of the shoulder bolts, the only limitation being that, when the heads of shoulder bolts are inserted therein, they may move in only one direction.

In yet a further alternate embodiment, rather than the shafts of the shoulder bolts being screwed into the top cover, the shafts are not threaded but are held in place through the use of retention screws that go through the shafts in the top cover to secure them.

In a preferred embodiment, a tamper sensor 22 is affixed to the underside of the PCB 16. The tamper sensor may be mechanical, optical, electrical or any type of sensor that can be armed during final assembly of the device and tripped when there is movement of the covers and/or PCB 16 after it is armed. By way of example and not limitation, if the tamper sensor is connected to an electrical circuit, the circuit will be completed when the sensor is armed. When the tamper sensor moves, the circuit breaks creating a tamper notification.

In a preferred embodiment, the tamper sensor 22 is a microswitch having an actuator plunger 24. When the plunger 24 is fully depressed, it arms the sensor 22. As shown in FIG. 2, the sensor 22 is armed when it comes to rest against a correspondingly located actuating structure 26 affixed to the bottom cover 14. In a preferred embodiment shown in FIG. 1, the actuating structure is a block. However any shape or type of trigger may be used so long as it is capable of triggering the tamper sensor 22 when the module 10 fully is assembled properly.

In an alternate embodiment of the present invention, rather than using an actuator structure and a microswitch having an actuator plunger, the tamper sensor 22 may be a photosensor that is tripped by the movement of one of the covers, such that a tamper notification will be generated.

In a preferred embodiment the tamper sensor 22 is affixed to the center of the underside of the PCB 16. However, the tamper sensor 22 may be placed anywhere on the PCB 16 with suitable modification of the reciprocal trigger component on the cover. After it is armed, the tamper sensor 22 will generate a tamper notification whenever either cover is moved in any direction. In alternate embodiments there may be numerous tamper switches 22 for which there are corresponding arming blocks 26.

When a tamper notification is received, the circuit on the PCB and/or the information therein and/or the access keys will either become disabled or destroyed, thereby protecting the sensitive information contained therein.

In a preferred embodiment such as shown in FIGS. 1 and 2, when the module 10 is assembled, the shaft 44 of shoulder bolts 32 are threaded through the corresponding holes in PCB 16 and into the top cover 12 so that the PCB 16 rests on the shoulders 42 of the shoulder bolts 32. The heads 40 and shoulders 42 of the shoulder bolts are then placed into the eyes of the keyholes 28 and then slid along the narrower portions 30 of the keyholes 28. In a preferred embodiment, as the bottom cover 14 is slid, the block 26 comes into contact with the tamper sensor 22 to arm the sensor. The bottom also includes retention holes 36 in which retention or set screws 38 or clips (not shown) are placed to lock the shoulder bolts 32 into place in the narrow part 30 of the keyhole slots 28. However, any locking mechanism for preventing movement of the bolts 32 in a contrary direction (i.e. towards the widest part of the slots 28) may be used. By way of example and not limitation, instead of a set screw 38, a spring-loaded lock at the end of the narrow channel 30 may be used which lock the bolts into place. Further, as shown in FIG. 1, there may be locking mechanisms 38 on each side of the bottom cover 14.

In a preferred embodiment, once the module is fully assembled, the tamper sensor 22 activates with less than an +/−0.040″ movement while still maintaining a tight seal around the PCB so that no access can be achieved by a probe or any other means.

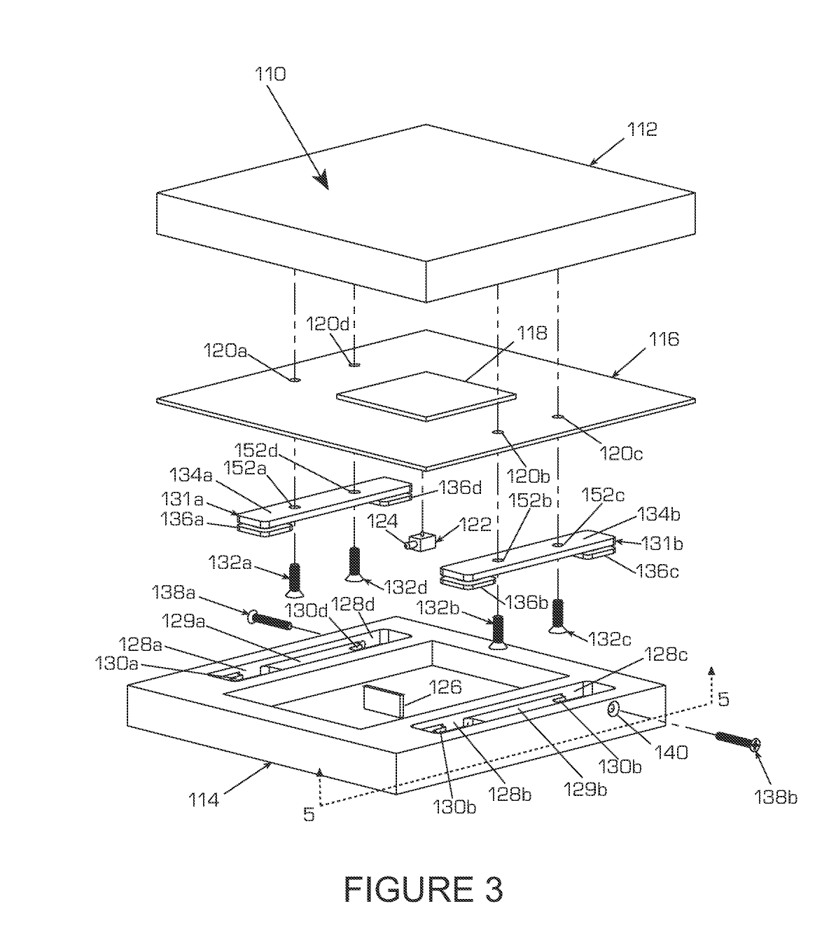

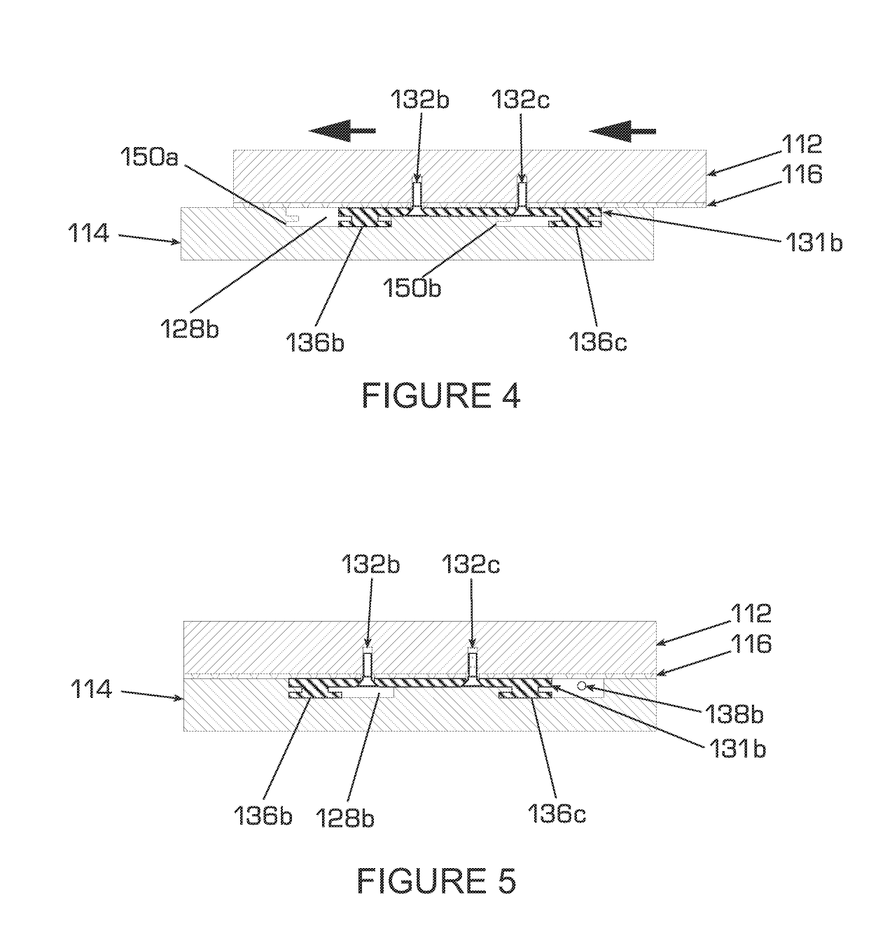

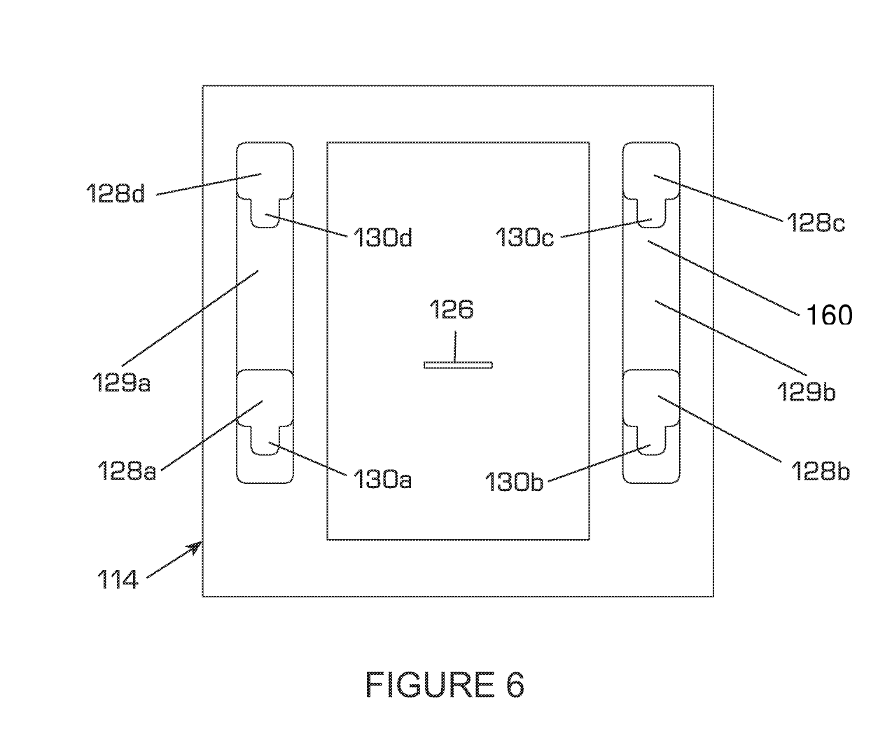

Referring next to FIG. 3, an alternate embodiment of the invention is shown. In this embodiment, instead of using the shoulder bolts 32 shown in FIGS. 1 and 2, a male structure 131 comprised of base 134 having nibs 136 extending therefrom are affixed to the bottom of a PCB 116. During assembly the male structure is attached to the PCB 116 and the top cover 112 through the use of screws 132 which are inserted through holes 152 and 120. A plan view of the PCB 116 attached to the top cover 112 is shown in FIG. 6. As shown in FIGS. 3 and 6, a tamper sensor 122 is affixed to the bottom of the PCB 116. Instead of using the keyhole slots 28 shown in FIGS. 1 and 2, the bottom cover 114 comprises one or more openings 128 which are configured to receive nibs 136. During assembly, as shown in FIGS. 4 and 5, the nibs 136 are inserted into holes 128 so that the base 134 rests against a top ledge 129 extending between the narrower portion 130c of opening 128c and the larger end of the immediately adjacent opening 128b. The nibs 136 are then slid into place as they are moved along one axis in channels 160 until they reach the very end 150 of channels 160 which are configured to interlock with nibs 136 as shown in FIGS. 4 and 5. In this manner, the top and bottom covers may move only in one direction. The nibs 136 are locked into place by retention screws 138 which are placed into holes 140, although any locking mechanism may be used to lock the nibs 136 in place. This embodiment also has an actuating block 126 for setting the actuator arm 124 of actuator 122 to arm the sensor when the module is fully assembled.

In alternative preferred embodiments the tamper sensors, and actuator trigger, female parts and retention holes may be located within the hollowed portion of top cover instead of within the bottom cover and the PCB may be attached to the bottom cover before being attached to the top cover. As such, in the embodiment shown in FIGS. 1 and 2, the shafts 44 of the shoulder bolts 32 would be threaded into the bottom cover 14 and the keyhole slots 28 would be fabricated into the top cover 12. Likewise in a similar alternate embodiment such as is shown in FIGS. 3-6, the base 134 and the nibs 136 would be attached to the top of the PCB 116 and then inserted into openings 28 having a channel 130 in the top cover 112.

In each of the preferred embodiments shown in FIGS. 1-6, the bottom cover and/or the top cover has a hollowed-out center portion to protect the circuitry on the PCB 16 from getting too hot. In this manner, when the components of the present invention fully are assembled, the bottom cover may act as a heat sink.

It is contemplated by this invention, that any male shaped component may be used to affix the PCB to a cover and which also can be inserted into a female component in the opposite cover and then locked into place.

In alternative embodiments, additional impediments to access can be added by adding additional linear or rotary contrary movements. In additional alternative embodiments, rather than utilizing keyhole slots, other means that require contrary or oblique motions such as, but not limited to, lips, guiderails, grooves, etc. may be used.

When the module of the present invention is fully assembled, anyone attempting to remove either cover will set off the tamper sensor(s) thereby either erasing or deactivating the access keys or disabling the circuit without destroying the entire circuit contained within the module. Thus, even authorized personnel move the cover in the contrary or oblique direction, the physical and electronic security and integrity of the module are maintained, as any movement will set off the tamper notification. Alternatively in some assembled embodiments, the entire circuit may be destroyed when the tamper sensor is set off.

Using the module of the present invention, entry into the protected area is prevented by requiring motion contrary or oblique to the original access. Further, even when the cover is moved in the contrary or oblique direction, the physical and electronic security and integrity are maintained, as any movement will set off the tamper notification. In another preferred embodiment, the tamper switch sends a signal externally giving notification of the tamper event to authorized personnel. Because a probe cannot be inserted under the cover with only the smallest of gaps without setting off the tamper sensor, the device of the present invention has passed FIPS testing.

It is also contemplated that instead of the module being square, the module may be any geometric shape so that instead of the keyholes and shoulder bolts being located in the corners, one or more of each may be placed along the inside perimeter thereof and so long as the tamper switch is engaged when the unit is fully assembled. It is also contemplated that there may be a plurality of tamper switches.

While particular embodiments and techniques of the present invention have been shown and illustrated herein, it will be understood that many changes, substitutions and modifications may be made by those persons skilled in the art. It will be appreciated from the above description of presently preferred embodiments and techniques that other configurations and techniques are possible and within the scope of the present invention. Thus, the present invention is not intended to be limited to the particular embodiments and techniques specifically discussed hereinabove.

What is claimed is:

1. A tamperproof module comprising:
a first cover;
a second cover;
a PCB containing circuitry thereon having a first side and a second side, the PCB being sandwiched between the first and second cover;
an interlocking system on opposite sides of the module, comprising:
a plurality of male components, and
a plurality of female components, each female component capable of receiving a reciprocal male component and configured so that the male components can be inserted into the female components and move only along the same axis; and
at least one tamper sensor capable of being tripped and located within the module wherein the tamper sensor becomes armed only when the module is fully assembled.

2. The tamperproof module of claim 1 further comprising a retention mechanism for locking the male components in place inside the female components when the module is fully assembled.

3. The tamperproof module of claim 1, whereby the circuitry will be disabled when the tamper sensor is tripped.

4. The tamperproof module of claim 1 whereby the circuitry will be destroyed when the tamper sensor is tripped.

5. The tamperproof module of claim 1, wherein the second cover comprises the female parts and the male parts are located on the side of the PCB facing the second cover.

6. The tamperproof module of claim 1 further comprising a trigger which arms the tamper sensor when the module is fully assembled.

6. The tamperproof module of claim 1, wherein the side of the PCB facing the second cover comprises a trigger which arms the tamper sensor when the module is fully assembled and the tamper sensor is located on the inside of the second cover so that it will come into contact with the tamper sensor when the module is fully assembled.

7. The tamperproof module of claim 1 wherein the second cover has a hollowed out center region which acts as a heat sink for the PCB.

8. The tamperproof module of claim 1, wherein the plurality of male components are shoulder bolts and the plurality of female components are keyhole shaped slots comprising a larger end configured to accept the head and shoulders of the shoulder bolts and a narrower end into which the shoulder bolts are slid without coming out of the second cover.

9. The module of claim 8 further comprising a retention mechanism for locking the shoulder bolts in place inside the narrower end of the keyhole shaped slots when the module is fully assembled.

10. The module of claim 8 wherein the shoulder bolts comprise a threaded shaft which is threaded through the second side of the PCB into corresponding holes in the first cover to hold the PCB in place whereby the first side of the PCB faces the first cover.

11. The tamperproof module of claim 1, wherein the plurality of male components comprise nibs and the plurality of female components are nib shaped slots configured to accept the nibs and permitting the nibs to be slid in one direction and retained in a nib shaped channel adjacent to the slots without coming out of the second cover.

12. The module of claim 11 further comprising a retention mechanism for locking the nibs in place inside the nib shaped channel when the module is being assembled.

13. The module of claim 11 wherein the nibs comprise a base which is attached to side of the PCB which faces the second cover and which rests on top of the area between the nib shaped holes in the second cover when the module is fully assembled.

14. The module of claim 13, wherein the base is attached to the PCB by screws which also are threaded into the first cover to hold the PCB in place.

15. A tamperproof module comprising:
a first cover;
a second cover;
a PCB containing circuitry thereon having a first side and a second side, the PCB being sandwiched between the first and second cover;
an interlocking system comprising:
a plurality of male components extending from at least two opposite sides of the same side of the PCB, and
a plurality of female components located within at least two opposite sides of the second cover, each female component capable of receiving a reciprocal male component and configured so that the male components of the PCB can be inserted into the female components and move only along the same axis; and
at least one tamper sensor capable of being tripped and located within the module wherein the tamper sensor becomes armed only when the module is fully assembled.

16. The module of claim 15 further comprising at least one retention screw for retaining at least one shoulder bolt into place after the module is assembled.

17. The module of claim 15 wherein when the tamper switch is set off, it causes the circuitry to become disabled.

18. The module of claim 15 wherein when the tamper switch is set off, the circuitry will be destroyed.

19. The tamperproof module of claim 1, wherein the second cover comprises a trigger which arms the tamper sensor when the module is fully assembled and the trigger sensor is located on the side facing the second cover.

20. A tamperproof module comprising:
a first cover;
a second cover;
a PCB containing sensitive cryptographic circuitry;
at least one tamper switch having an actuator, the tamper switch being attached to the sensitive cryptographic circuitry;
at least one shoulder bolt having a head, non-threaded shoulder area and a shaft;
the cover proximate the tamper switch comprising keyholes corresponding to the number of shoulder bolts, whereby the heads of the shoulder bolts are inserted into the eye of the corresponding keyhole, the cover further comprising an actuation structure inside thereof which will come into contact with the tamper switch when the module is assembled;
wherein the at least one keyhole is oriented so that as the at least one corresponding shoulder bolt is moved therein to the locked position, the actuator of the tamper switch will come into contact with the actuation structure;
whereby after the module is assembled, any attempt to remove either cover will set off the tamper switch.
